(19) United States
(12) Patent Application Publication
(10) Pub. No.: US 2002/0015506 A1
(43) Pub. Date: Feb. 7, 2002

(54) Remote programming and control means for a hearing aid

(75) Inventors: John G. Aceti, West Windsor, NJ (US); Walter P. Sjursen, Washington Crossing, PA (US); David A. Preves, Princeton Junction, NJ (US); Frederick J. Fritz, Skillman, NJ (US)

Correspondence Address: HAMILTON BROOK SMITH AND REYNOLDS, P.C., TWO MILITIA DR, LEXINGTON, MA, 02421-4799, US

(73) Assignee: Songbird Hearing, Inc.

(21) Appl. No.: 09/805,743

(22) Filed: Mar. 13, 2001

Related U.S. Application Data
(60) Provisional application No. 60/188,857, filed on Mar. 13, 2000.
(60) Provisional application No. 60/188,997, filed on Mar. 13, 2000.
(60) Provisional application No. 60/188,996, filed on Mar. 13, 2000.
(60) Provisional application No. 60/188,721, filed on Mar. 13, 2000.

(51) Int. Cl. H04R 25/00

(52) U.S. Cl. 381/314; 381/312; 381/317

(57) ABSTRACT

In an illustrative embodiment of the present invention, a selector module is provided to a user for selecting one of multiple acoustical formats of a hearing aid device. Generally, a keypad is pressed by a user to select an acoustical format, whereby a command is transmitted to the hearing aid. In a specific application, the command is transmitted via a wireless protocol. A received command is then decoded to program the hearing aid to a selected acoustical format. Preferably, the acoustical format defines an acoustical response of the hearing aid device for an entire continuous range of frequencies detectable by a human ear.

### RELATED APPLICATION

This application claims the benefit of U.S. Provisional Application No. 60/188,857 filed on Mar. 13, 2000, the entire teachings of which are incorporated herein by reference.

This application is related to copending U.S. applications:

| ATTORNEY | | |
|---|---|---|
| DOCKET NO. | APPLICATION NO. | TITLE |
| SMI-13459pA | 09/524,666 | Disposable |
| | | Modular Hearing |
| | | Aid |
| 2506.1005-001 | 09/524,043 | Mass Produced |
| | | Hearing Aid With |
| | | a Limited Set of |
| | | Acoustical |
| | | Formats |
| 2506.1013-001 | 09/524,040 | One-Size-Fits- |
| | | All Uni-Ear |
| | | Hearing |
| | | Instrument |
| 2506.2012-000 | 60/188,997 | Hearing Aid With |
| | | Flexible Shell |
| 2506.2013-000 | 60/188,996 | Hearing Aid |
| | | Prescription |
| | | Selector |
| 2506.2014-000 | 60/188,721 | Through-Hole and |
| | | Surface Mount |
| | | Technologies for |
| | | Highly- |
| | | Automatable |
| | | Hearing Aid |
| | | Receivers |
| 2506.2019-000 | 60/188,857 | Remote |
| | | Programming and |
| | | Control Means |
| | | for a Hearing |
| | | Aid |

all filed Mar. 13, 2000, the entire teachings of which are incorporated herein by reference.

This application is also related to copending U.S. applications:

| ATTORNEY DOCKET NO. | TITLE |
|---|---|
| 2506.2008-005 | Hearing Aid with Tinted |
| | Components |
| 2506.2013-001 | Hearing Aid Format Selector |
| 2506.1009-005 | Disposable Modular Hearing |
| | Aid |

all filed on even date herewith, the entire teachings of which are incorporated by reference.

### BACKGROUND OF THE INVENTION

The process of fitting hearing aids is not always an exact science. It is therefore desirable to easily and efficiently demonstrate characteristics of a hearing aid device such as sound quality for prospective users before dispensing a hearing aid for use.

Various master hearing aids and hearing aid programming devices have been used to dispense hearing aids. Until recently, most of the test units have been large table-top designs including panel-mounted microphones and headphones that have no relation to the transducers or circuitry actually used in the hearing aids to be fitted. Thus, a corresponding dispensed product to correct a hearing impaired patient typically falls short of a user's expectations and the patient has to revisit an audiologist for another fitting.

More recently, hand-held programming devices have been developed for fitting programmable analog and digital hearing aids. These devices typically enable an audiologist to adjust the response of a hearing aid device by changing one parameter at a time. This can be a complex procedure because it requires the audiologist to know the effect of changing each parameter.

### SUMMARY OF THE INVENTION

The present invention is generally directed to a system and method for modifying an acoustical response of a hearing aid device. In an illustrative embodiment, a hearing aid can be programmed to provide an acoustical response for one of multiple selectable acoustical formats. Selection of an acoustical format is achieved by transmitting a command and then receiving the command at a hearing aid. Based on the received command, an acoustical response of the hearing aid is then programmed so that an acoustical input of the hearing aid is amplified according to a selected acoustical format. Consequently, a user can program a hearing aid device disposed in an ear canal without having to remove the hearing aid.

In one application, an acoustical format defines an acoustical response of the hearing aid over each of an entire continuous range of audible frequencies. In yet another application, the command is transmitted form a selector module to a hearing aid via a wireless signal.

A command transmitted by a user to select an acoustical format can include digital data that is stored in a memory device of the hearing aid. Thus, raw digital data of the command can be used as control data to select or program an acoustical format of the hearing aid.

In a specific application, raw digital data of a command is latched to drive at least one input of a digital filter or other electronics also disposed in the hearing aid device. At least a portion of the latched data is used to select a desired acoustical format. Preferably, digital data is latched to drive a hardwired digital filter or related circuitry.

Although a method of selecting an acoustical format can vary, one method for selecting an acoustical format involves pressing a keypad of a wireless transmitter. Upon detection of a pressed key of a selector module, a corresponding command is transmitted to the hearing aid device to program a format. Consequently, a hearing aid device can be reprogrammed simply by pressing another program key of the selector module.

In an alternate application, the hearing aid device is optionally permanent so that the device cannot be accidentally reprogrammed. That is, the hearing aid can be programmed only once after to set an acoustical format.

The hardware for storing digital data or a command for selecting an acoustical format can be volatile memory such as RAM (Random Access Memory). When used in lieu of EEPROM memory, RAM memory can lose its content when depowered but it is generally cheaper. EEPROM is reprogrammable and retains a previous memory setting even when depowered.

In one application, the hearing aid supporting one of multiple formats is disposable. Thus, it is not necessary to spend hours cleaning the hearing aid after an extended period of use. Nor is it necessary to fix a damaged hearing aid device because another nearly identical device can be purchased at a relatively low cost. It is therefore not a devastating ordeal if the hearing aid is accidentally lost either.

Another aspect of the present invention involves programming an acoustical format by holding the hearing aid device near a phone receiver and pressing at least one keypad to select a format. In one application, a predefined sequence of numbers of the phone can be pressed to select an acoustical format. Thus, it is possible to provide a code that indicates to the hearing aid that it should reprogram an acoustical format.

In a general sense, another aspect of the present invention involves filtering an audible input of the hearing aid to detect a programming command. Upon receipt of a valid command, the hearing aid can be programmed accordingly. In a specific application, the audible programming command is generated via DTMF (Dual Tone Multiple Frequency) signals such as tones generated by telephone devices, although any type of wireless signal can be used to select an acoustical format.

Yet another aspect of the present invention involves compensating for a variation in a component of the hearing aid device so that the acoustical response of the hearing aid conforms to a standard. For example, a characteristic of a component assembled within a hearing aid may fall outside a given tolerance so that an overall response of the hearing aid would not conform to a desired standard. A compensation factor can be programmed in the hearing aid to compensate for a variation in the component.

Preferably, a compensation factor associated with a tested component is disposed in a memory device of the hearing aid. An acoustical response of the hearing aid is then adjusted based on the compensation factor to account for variability of the corresponding tested component. In this way, a group of hearing aids each of which include a tested component can be individually programmed so that a selected acoustical response of a corresponding hearing aid conforms to a standard.

The present invention is also generally directed to an apparatus and method for modifying an acoustical response of a hearing aid. This involves testing a component to be used the hearing aid by measuring a characteristic of the component. An appropriate compensation factor is then assigned to correct for a potential variation in the tested component. This compensation factor is then preferably stored in a memory device for the component disposed in the hearing aid.

By compensating for variations of a component, the response of a hearing aid can be precisely controlled so that an overall response of a selected acoustical format more closely conforms to a standard. Thus, if the hearing aid is disposable, a replacement hearing aid potentially including deviant components will typically provide an acoustical response that is undetectably similar to other hearing aids programmed with the same format.

One component of the hearing aid that can be tested for variations is a microphone device that is used to detect an acoustical input signal. The microphone is preferably tested to determine how it varies from a desired standard, after which, a compensation factor is assigned to correct for a measured variation of the component.

A compensation factor is generally calculated by determining what effect a component variation will have on a production hearing aid. For example, a compensation factor can take into account the variation of the component from a standard to eliminate or reduce a detrimental effect that the tested component will have on the overall acoustical response of the hearing aid.

In one application, the component is a microphone including an electronic circuit board that is tested to determine a corresponding variation. In a specific application, the electronic circuit board can include an amplifier circuit that must be trimmed. A compensation factor can be stored in a memory device disposed within the electronic circuit.

Although a compensation factor generally can be programmed at any stage in a manufacturing process, the compensation factor can be stored in the memory device prior to assembly of the component in a hearing aid. Consequently, compensation information can be programmed to reside with the component itself and no extra effort is necessary to track a part and program a corresponding compensation factor at a later time. Alternatively, a compensation factor can be programmed after the hearing aid is assembled with a corresponding component.

A single hearing aid can include multiple components, each of which is assigned a unique compensation factor for trimming an aspect of the hearing aid. Thus, a hearing aid device can include multiple compensation factors.

Testing is optionally performed on a fully assembled hearing aid and a compensation for a variation caused by a combination of components also can be stored in a memory device of the hearing to compensate for errors. Based on these techniques, it is possible to reduce an overall cost of the hearing aid device since otherwise unacceptable components can be used in the assembly of precise and accurate hearing aid devices that conform to a standard.

The memory device for storing a compensation factor is optionally RAM (Random Access Memory). An advantage to using RAM is its low cost. Alternatively the memory device for storing a compensation factor is EEPROM (Electrically Erasable Programmable Read Only Memory) that can be reprogrammed.

In one application, the memory device is used to store not only one or multiple compensation factors, but also an acoustical format selected for the hearing aid. For example, multiple bits are stored in the memory device to identify which of multiple acoustical formats is selected.

In one application, an acoustical format defines an acoustical response of the hearing aid over each of an entire range of audible frequencies.

The technique for utilizing a digitally encoded compensation factor involves latching compensation data into a register device so that it drives circuitry disposed between a microphone and speaker of the hearing aid. The latched data is typically used to trim a circuit and compensate for a variation in one or multiple pre-tested components. This technique simplifies final production testing since an assembled hearing aid device programmed with compensation data is more likely to conform with a desired specification. More specifically, certain component variations will be corrected by the compensation factor assigned to the component. Thus, it is easier to fine-tune the hearing aid device at a final stage in production prior to use.

Another aspect of the present invention involves testing multiple components of a similar type and grouping the components based on a corresponding deviation from a standard. A compensation factor is then assigned to a group of similarly deviant components. After assembly of the hearing aid, memory within the hearing aid can be programmed with a corresponding compensation factor to correct for a component variation.

In one application, a compensation factor can be used to adjust a gain of the hearing aid. Similarly, a compensation factor can be used to adjust on offset of the hearing aid of an electronic signal therein. Generally, any measurable characteristic can be compensated based on a compensation factor. As previously discussed, components such as a microphone or speaker for a hearing aid can be tested and assigned an appropriate compensation factor to account for variances from a standard such as a norm.

More specifically, a user does not have to set tiny switches located on the hearing aid device to set an acoustical format. It is also unnecessary to tether a cable to the hearing aid for selecting a particular format. Nor does a user need not worry about removing the hearing aid to change an acoustical format selection.

Based on certain principles of the present invention, a user can also more easily compare acoustical formats of the hearing aid and select a format best-suited for a particular application. For example, one acoustical format may provide better sound for classical musical while another may provide better performance to a user for conversational speech.

The present invention is generally directed to a system and method for programming an acoustical response of a hearing aid device. In an illustrative embodiment, a hearing aid can be programmed to provide an acoustical response for one of multiple selectable acoustical formats. The hearing aid is temporarily coupled to a programmer module via, for example a cable connection. Programming of an acoustical format is achieved by transmitting a command and then receiving the command at a hearing aid. Based on the received command, an acoustical response of the hearing aid is then programmed so that an acoustical input of the hearing aid is amplified according to a selected acoustical format. Consequently, a user can program a hearing aid device while the hearing aid is connected to a programmer module, which is later detached from the hearing aid so that a cable is not tethered to the hearing aid while used by a patient.

In one application, an acoustical format defines an acoustical response of the hearing aid over each of an entire continuous range of audible frequencies.

A command transmitted by a user to program an acoustical format can include digital data that is stored in a memory device of the hearing aid. Thus, raw digital data of the command can be used as control data to program or program an acoustical format of the hearing aid.

In a specific application, raw digital data of a command is latched to drive at least one input of a digital filter or other electronics also disposed in the hearing aid device. At least a portion of the latched data is used to select a desired acoustical format. Preferably, digital data is latched to drive a hardwired digital filter or related circuitry.

Although a method of programming an acoustical format can vary, one method for selecting an acoustical format involves pressing a keypad of a transmitter. Upon detection of a pressed key of a programmer module, a corresponding command is transmitted to the hearing aid device to program a format.

In an alternate application, the hearing aid device is optionally permanent so that the device cannot be accidentally reprogrammed. That is, the hearing aid can be programmed only once after to set an acoustical format.

In one application, the hearing aid supporting one of multiple formats is disposable. Thus, it is not necessary to spend hours cleaning the hearing aid after an extended period of use. Nor is it necessary to fix a damaged hearing aid device because another nearly identical device can be purchased at a relatively low cost. It is therefore not a devastating ordeal if the hearing aid is accidentally lost either.

Yet another aspect of the present invention involves compensating for a variation in a component of the hearing aid device so that the acoustical response of the hearing aid conforms to a standard. For example, a characteristic of a component assembled within a hearing aid may fall outside a given tolerance so that an overall response of the hearing aid would not conform to a desired standard. A compensation factor can be programmed in the hearing aid to compensate for a variation in the component.

Preferably, a compensation factor associated with a tested component is disposed in a memory device of the hearing aid. An acoustical response of the hearing aid is then adjusted based on the compensation factor to account for variability of the corresponding tested component. In this way, a group of hearing aids each of which include a tested component can be individually programmed so that a selected acoustical response of a corresponding hearing aid conforms to a standard.

Yet another aspect of the present invention involves providing a patient with an un-programmed hearing aid device. The user then programs a hearing aid device by temporarily coupling the hearing aid to a programming unit and transmitting an appropriate command for setting an acoustical format. In one application, a single key of a programmer module is pressed to program an acoustical format. Also, the programmer module can be a wireless device for programming a blank hearing aid.

### BRIEF DESCRIPTION OF THE DRAWINGS

FIG. 1 is a block diagram illustrating a tester for grouping components according to certain principles of the present invention.

FIG. 2 is a flow chart illustrating a method for assigning a compensation factor to a component according to certain principles of the present invention.

FIG. 3 is a block diagram for testing a component according to certain principles of the present invention.

FIG. 4 is a more detailed block diagram for testing a component and utilizing a compensation factor to correct for deviations according to certain principles of the present invention.

FIG. 5 is a flow chart illustrating a method for testing a component according to certain principles of the present invention.

FIG. 6 is a block diagram of a remotely controlled hearing aid device and selector module according to certain principles of the present invention.

FIG. 7 is a more detailed block diagram of a wireless selector module for programming a hearing aid device according to certain principles of the present invention.

FIG. 8 is a block diagram of a selector module for programming a hearing aid according to certain principles of the present invention.

FIG. 9 is a block diagram illustrating a cradle for programming a hearing aid device according to certain principles of the present invention.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

### DETAILED DESCRIPTION OF THE INVENTION

A description of preferred embodiments of the invention follows.

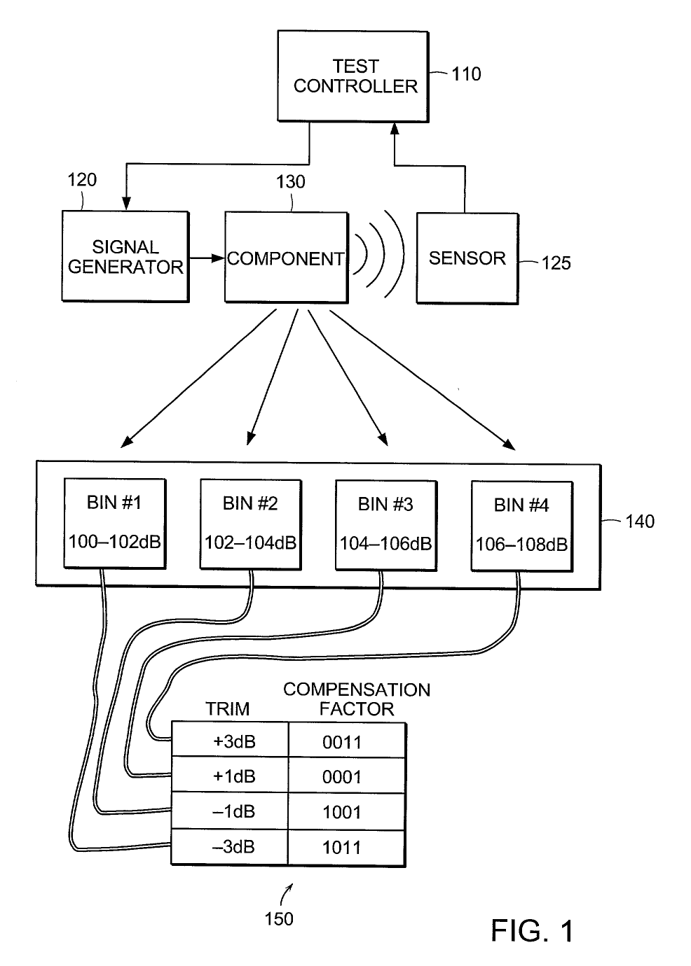

FIG. 1 is a block diagram of a production tester according to certain principles of the present invention. Although the specific embodiment describes a method of testing a component such as that used in assembly of a hearing aid device, component tester 100 or a similar device can be used to test any type of components.

Generally, a compensation factor is assigned to a tested component depending upon a variation of the component from a standard. When a device such as a hearing is assembled including the component, the compensation factor corresponding to the component is programmed in the device so that response of the device conforms to a desired standard or norm. Thus, a disposable device including varying components can be replaced by another device having nearly identical characteristics.

This aspect of the present invention is useful in a hearing aid application since a hearing aid device set to a selected format can be replaced with another hearing aid set to the same format, while providing almost identical acoustical performance. In situations where the overall assembled device must fall within a narrow tolerance, this aspect of the present invention greatly improves production yields so that an overall cost of the corresponding product is substantially reduced.

Component tester 100 is used to test component under test 130 such as a receiver or speaker of a hearing aid device. Preferably, a hearing aid device including the tested component 130 supports multiple acoustical formats for correcting a corresponding hearing impairment of a user. A single acoustical format can define an acoustical response of the hearing aid for the entire range of audible frequencies.

In one application, the hearing aid device is disposable and supports a fixed acoustical format. Details of such a hearing aid device are discussed in pending U.S. patent application Ser. No. 09/524,043 filed Mar. 13, 2000, entitled “Mass Produced Hearing Aid with a Limited Set of Acoustical Formats,” the entire teachings of which are incorporated by reference.

Test controller 110 such as a PC (Personal Computer) device is programmed with a test program to test component 130. More specifically, signal generator 120 generates a voltage at a particular frequency to drive component under test 130 such as a speaker. Although component 130 can be tested at multiple settings, in certain cases a single test is adequate. In the present application, the signal generator 120 for example generates a 1000 Hertz. Based on this input, component 130 generates an acoustical output in response to the input voltage. Thus, a characteristic of component 130 is measured at acoustical sensor 125.

Normally, a component 130 such as a speaker or receiver for a hearing aid of the present invention produces a sound output of 104 dBSPL (dBSPL is equal to 20.log9P/Pref), where P equals the sound pressure and Pred is the reference pressure of 20 micropascals) as measured at acoustical sensor 125 when tested as previously described. As expected, each component 130 of a group of components 130 will vary from the norm.

Test controller 110 compares the characteristic or variation of the tested component 130 with a standard to determine which of multiple bins 140 component 130 shall be grouped. A component 130 is otherwise discarded if it does not fall within a desired tolerance range. For example, a component can be so defective that it can not be used on the assembly of a hearing aid device.

Each bin 140 is used to group components 130 having similar characteristics. For example, tested components 130 that produce a sound output between 100 and 102 dBSPL for a given test input are grouped into bin #1. Similarly, tested components 130 that produce a sound output as detected by acoustical sensor 125 between 102 and 104 dBSPL are grouped together in bin #2, and so on.

In the present example, each of the components 130 in a corresponding bin 140 shall be assembled into a hearing aid device. Based on the circuit that will be coupled to the component 130 and an overall desired acoustical response of the device, a nominal standard as such as 104 dBSPL and a compensation factor 150 is calculated for each bin 140 or group of components. A compensation factor 150 is eventually used to compensate for a variation in a component so that the output of the hearing aid conforms to a standard.

As shown, a nominal value of each bin, such as 101 dBSPL for bin #1, is compared to the desired standard of 104 dBSPL. The difference between the nominal value for a bin 140 and desired nominal standard is used to determine how to trim a hearing aid device to reduce errors. For example, bin #1 components generally require a compensation of +3 dB. Based on the corresponding effect the part will have on an end-assembly circuit, a compensation factor 150 is determined.

Compensation factor 150 can be an encoded set of digital data that is used to control inputs of analog and digital electronic circuitry of the hearing aid device. Using the encoded data, a gain or offset of a circuit can be adjusted based on compensation factor 150. This aspect of the invention will be described in more detail later in the specification.

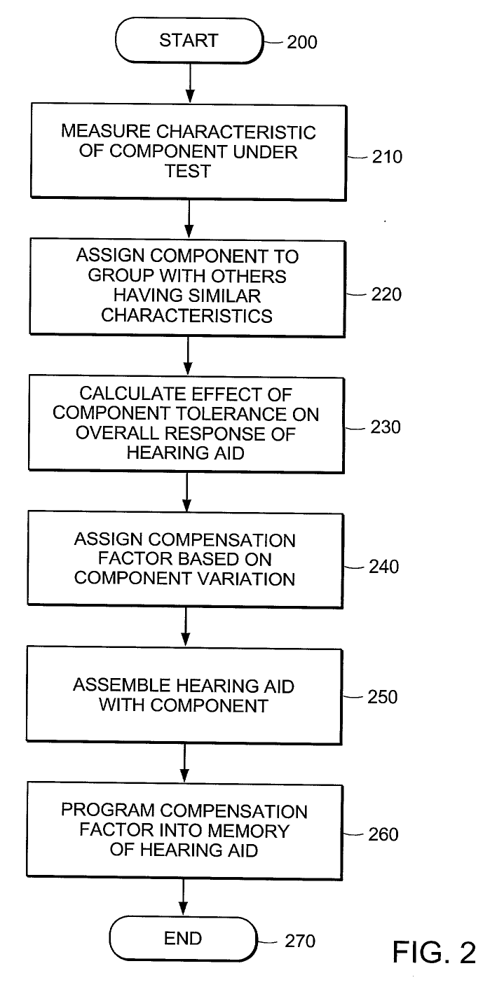

FIG. 2 is a flow chart illustrating a method of testing a component for variations and assigning a corresponding compensation factor according to certain principles of the present invention. Step 200 indicates an entry point of the routine.

In step 210, a characteristic of the component is tested using component tester 100. Based on a measured variation, the component 130 is grouped with other tested components 130 and stored in a corresponding bin 140. Consequently, components 130 grouped in a bin 140 are then assembled into an end product such as a hearing aid device.

In step 230, a design analysis is performed to determine how a component variation will effect the overall response of the assembled hearing aid. To correct for the anticipated effect of a component 130, compensation factor 150 is assigned to the bin 140 of similar components 130 in step 240.

A group of hearing aid devices is then assembled in step 250 using the components 130 from a particular bin 140 and the assigned compensation factor is stored into memory of the hearing aid. Consequently, the compensation factor 150 can be used to adjust a gain or offset at a particular stage of a multistage analog or digital circuit of the hearing aid device.

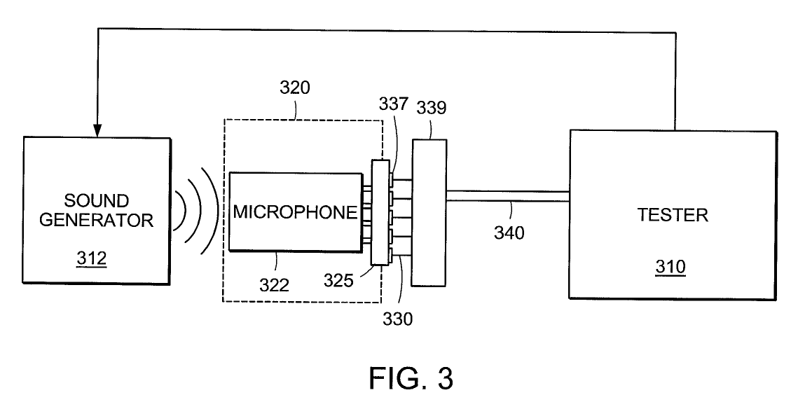

FIG. 3 is a diagram of a test unit for analyzing component variation according to certain principles of the present invention. Component 320 can be either a single electronic part, an assembly of multiple parts, or even a mechanical device. As shown, a component 320 including a transducer such as a microphone 322 is tested along with a corresponding electronic circuit 325 via component tester 310.

Component tester 310 such as a PC device controls how a component 322 is tested. For example, sound generator 312 such as a sound generator device 312 is coupled to component tester 310 for controlling its output. One or multiple sample tones is produced by sound generator 312. This sound is sensed at microphone 322, which is coupled to electronic circuit 325. In a preferred application, component tester 310 provides power to component 320 through cable 340 to power electronic circuitry.

Electronic circuit 325 can include an amplifier circuit that is used to amplify a small signal generated by microphone 322. Test points on the circuit board 325 at an output stage of the amplifier are optionally connected to electrically conductive component test pads 337 so that the sensed signal can be measured at component tester 310. A signal generated by electronic circuit 325 is coupled to test pins 330 in contact with test pads 337 of tested component 320 for measuring an aspect of the component 320.

A signal generated by electronic circuit 325 can be buffered at test head assembly and further driven trough cable 340 to a measuring instrument such as an oscilloscope or other electronic measuring device at component tester 310. Accordingly, a variation of component 320 is measured and compared to a standard.

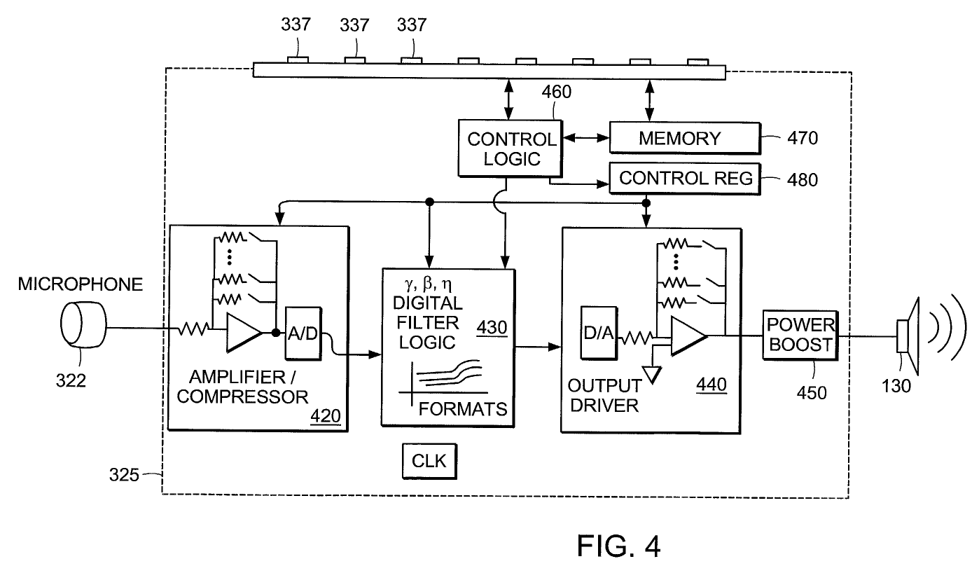

FIG. 4 is a block diagram more particularly illustrating a tested component according to certain principles of the present invention.

As shown, microphone 322 is coupled to electronic circuit 325 including multiple stages of analog and digital circuitry. Test points are chosen at various stages of electronic circuit 325 and are fed to component tester 310 through test pads 337. For instance, an output of the amplifier/compressor stage 420 is connected to test pad 337 so that the corresponding signal can be measured at component tester 310.

As previously, discussed, a controlled acoustical input is provided at microphone 322 and a generated signal is amplified by amplifier/compressor circuit. The amplified signal is then measured at component tester 310 to determine how its characteristics deviate from a standard. Based on the measured deviation, a compensation factor is programmed into memory 470 of electronic circuit 325. This is achieved by transmitting a compensation factor in the form of digitally encoded data from component tester 310 to memory 470. Control logic 460 includes hardware to support the data transfer into memory device 470.

Multiple stages of the electronic circuit 325 can be analyzed so that multiple compensation factors 150 are stored in memory device 470, each of which is used to trim an aspect of circuit 325. For example, one compensation factor 150 is downloaded into memory 470 to compensate for an overall response of the hearing aid device.

To support testing, control logic 460 enables certain circuits to be bypassed. For example, digital filter 430 can be placed in a by-pass made so that only specific portions of a circuit are tested. Thus, it is possible to isolate a stage of circuit 325 and determine an appropriate compensation factor for a particular stage on aspect of circuit 420.

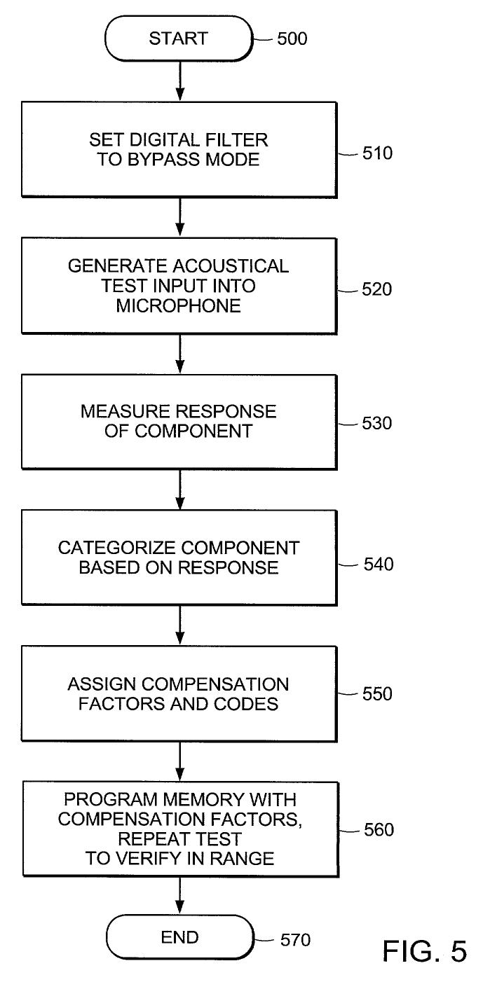

FIG. 5 is a flow chart illustrating a method of testing a component and storing digital data in memory to compensate for a variation of the component according to certain principles of the present invention. Step 500 shows an entry point into the flow chart.

Initially, electronic circuit 325 is set to the appropriate mode for testing a stage or multiple stages in step 510. A mode is preferably selected by generating a corresponding signal and driving electronic circuit 325 through test pads 337. One method of setting the circuit into an appropriate mode is to transmit a data command that enables a test mode. Following in step 520, an acoustical test input is applied to microphone 322.

Based on a response of component 320 including microphone 322 and electronic circuit 325 as measured in step 530, the component is generally grouped with other components having similar characteristics in step 540. A compensation factor 150 to compensate for a measured deviation is then assigned in step 550. Preferably, compensation factor 150 is a multi-bit value that is programmed in memory 470 of the corresponding hearing aid into which the component 320 is assembled in step 550.

After programming a compensation factor 150 in the hearing aid, the test process is optionally repeated to verify that the variation of a component 322 is properly compensated. For instance, the component 322 is retested to verify that it conforms to a standard based on a use of a compensation factor 150. Repeating the test can also be used to verify that the compensation factor is properly downloaded into memory 470 and latched into control register 480 that drives stages of the electronic circuit 325 between microphone 322 and speaker 680. It should be noted that speaker 680 need not be included to test component 320.

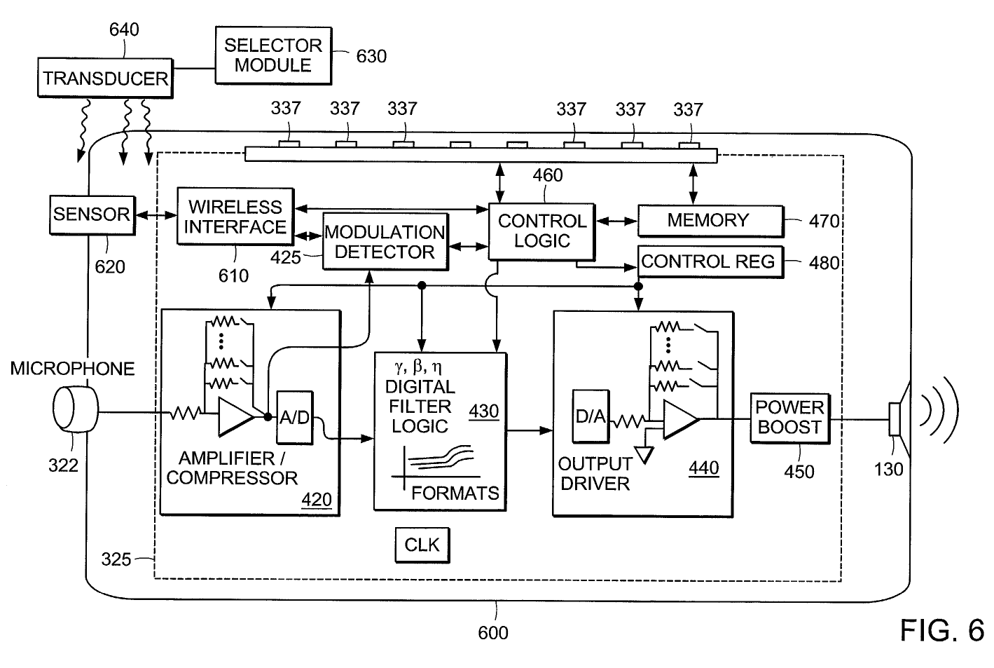

FIG. 6 is a block diagram of a wireless module for selecting an acoustical format according to certain principles of the present invention. Generally, electronic circuit 325 disposed between microphone 322 and speaker 680 includes a memory device 470 for storing one or multiple compensation factors 150 and acoustical setting information. A wireless interface 610 is provided so that a user can select one of multiple acoustical formats supported by hearing aid device 600. In one application, an acoustical format defines a response of hearing aid 600 for the entire audible range of a human ear.

Wireless selector module 630 in conjunction with transducer 640 is generally used for transmitting a command to hearing aid 600. One command transmitted by selector module 630 is used to select one of multiple acoustical formats supported by hearing aid 600. Each format defines an appropriate frequency response or transfer function for amplifying an acoustical input. Preferably, each of multiple hearing aid devices 600 programmed with a particular format produce the same output for a selected acoustical input.

Typically, one of nine acoustical formats can be selected by a user. Details of an exemplary set of formats is described in pending U.S. patent application Ser. No. 09/524,043 filed Mar. 13, 2000, entitled “Mass Produced Hearing Aid with a Limited Set of Acoustical Formats,” the entire teachings of which are incorporated herein by reference. It should be noted that although that invention describes an apparatus and method of programming a hearing aid with a fixed acoustical format, one aspect of the present invention involves programming a selected one of multiple acoustical formats of a hearing aid device.

Transducer 620 is disposed on hearing aid device 600 to receive a wireless signal from selector module 620. Generally a transducer can be any suitable device for transmitting and receiving data. For example, one embodiment of the present invention involves utilizing infrared technology to transmit data via a line of sight wireless connection. In such a case, transducer 640 is an infrared transmitting LED device and hearing aid transducer 620 is an infrared photo sensor for detecting a wireless signal transmitted by selector module 630.

The media used to transfer data from selector module 630 is not limited to the use of infrared technology. Other types of media can be supported. For instance, ultrasound, induction coupling, capacitive coupling, RF (Radio Frequency) such as AM (Amplitude Modulation) or FM (Frequency Modulation), vibrational, and other suitable technology can be used to support data transfers between selector module 630 and hearing aid 600.

The wireless signal received by transducer 620 of hearing aid 600 produces an electronic signal that drives wireless receiver interface 610. Interface 610 typically includes an amplifier circuit to boost the received signal into a suitable range for further processing. For instance, the boosted signal is fed into modulation detection circuit 425 that demodulates the signal for retrieving encoded digital data. The digital data is preferably a command transmitted by selector module 630.

One aspect of the present invention involves transmitting a limited stream of data information to select an acoustical format of hearing aid 600. This is achieved by transmitting reduced data information such as a 4-bit data packet for selecting a format. When detected, the digital information is stored in a memory device 470 such as RAM or EEPROM. An overall acoustical format is then programmed into electronic circuit 325 by latching the digital information into control register 480.

Latched data in control register 480 is then used to drive stages of the electronic circuit 325. For example, digital data for selecting an acoustical format preferably drives digital filter logic 430. As previously discussed, one of multiple acoustical formats supported by digital filter 430 is selected by driving digital filter logic 430 with the appropriate control signals.

Format selection bits in control register 480 are optimally decoded for selecting a particular acoustical format. For instance, there can be three inputs to digital filter logic 430 for selecting an acoustical format in a specific application.

One aspect of digital filter 430 is low frequency gain, β. β of digital filter logic 430 is set by storing 2 bits in control register 480 to the appropriate logic level.

Digital filter 430 also includes an input for adjusting the high frequency gain, γ, for a corresponding acoustical format. An appropriate γ is also selected by setting 2 bits in control register 480 to the appropriate logic level.

Lastly, digital filter 430 also includes an input for adjusting the slope of the frequency response, η, associated with a particular format. 2 bits of control register 480 are used to select the slope corresponding to a selected acoustical format.

Although a total of 6 bits is preferably used to select a particular format, only 4 bits are necessary to identify each of multiple acoustical formats. Thus, if a 4-bit value is received at wireless interface 610, the 4-bit value can be decoded via digital logic to produce six appropriately set bits for selecting the proper β, γ and η corresponding to a selected acoustical format. More details regarding the selection of a format are discussed in U.S. patent application Ser. No. 09/524,043, previously incorporated by reference, and U.S. patent application Ser. No. (2506.1015-000), filed on Jun. 2, 1999, entitled “Hearing Aid Digital Filter,” the entire teachings of which are incorporated herein by reference.

As previously discussed, one aspect of the present invention involves programming an acoustical format via a wireless signal using a limited set of data information. A feature of the electronic circuit 325 that renders this possible is the analog and digital circuitry. It is potentially hard-wired and designed to support multiple acoustical format.

Electronic circuitry 325 is typically adjusted at two stages of production. First, electronic circuit 325 such as a piece of silicon is preferably trimmed during wafer fabrication so that a response of a corresponding A/D converter or amplifier of the circuit 325 falls within a particular acceptable range. This initial process of trimming ensures that a response of electronic circuit 325 generally conforms to a standard.

Second, a variation of individual components is measured to trim a hearing aid device 600. Since components such as microphone 322 and speaker 680 can vary, a technique as previously discussed is used to compensate for these component variations. Consequently, it is not necessary to transmit trim information or a compensation factor 150 to hearing aid 600 via a command transmitted by selector module 630. Rather, a variation of one or multiple components of hearing aid 600 is eliminated or reduced using one or multiple previously programmed compensation factors 150 stored in control register 480 of hearing aid 600.

Based on this technique, it is possible to provide a disposable hearing aid device 600 that is reprogrammable. More specifically, only selection information is transmitted to the hearing aid for selecting a format. An unprogrammed hearing aid device 600 can be mailed to a user for reprogramming in the user's own home. According to this method of reprogramming a hearing aid 600, it is not necessary for a patient to revisit the audiologist for programming a particular hearing aid. Preferably, a difference in the variation of hearing aids programmed with a specific acoustical format is undetectable to a typical user.

Another method of programming hearing aid 600 is to provide modulation detection circuitry 425 in circuit 325 for monitoring an acoustical input provided by microphone 322. For example, hearing aid 600 is optionally held to a phone receiver while a keypad is pressed to produce a DTMF signal. When modulation detection circuit detects an appropriate signal such as a pressed number or sequence of pressed numbers, a digital data packet corresponding to a received command is stored in memory 470 for selecting the appropriate acoustical format.

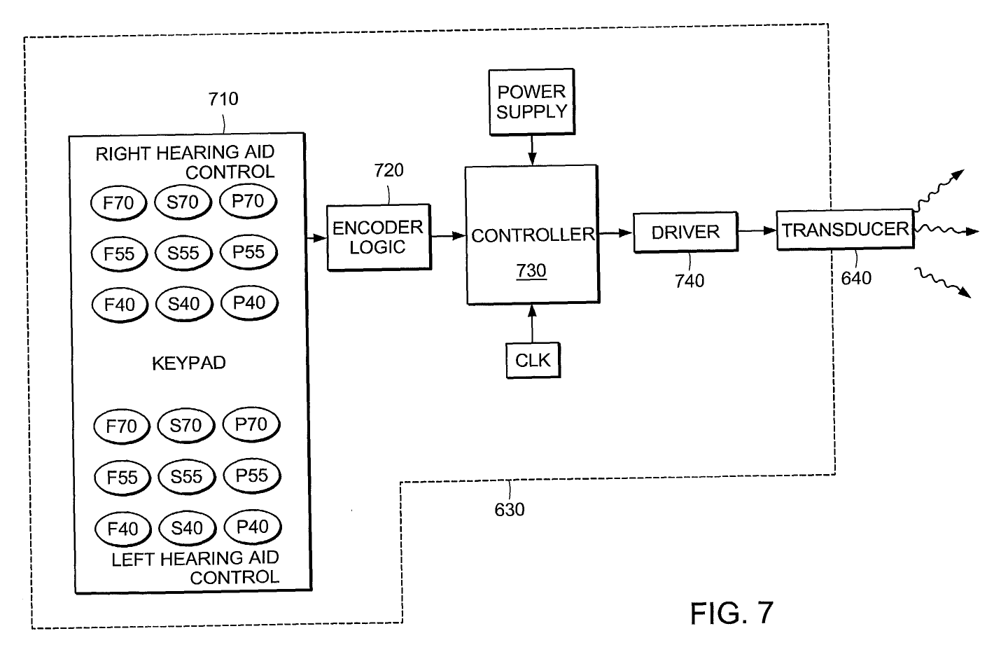

FIG. 7 is a block diagram of a selector module for reprogramming a hearing aid according to certain principles of the present invention.

As previously discussed, selector module 630 is used to generate a wireless signal for transmitting a command to hearing aid 600.

Keypad 710 provides multiple keys for adjusting hearing aids in both a right and left ear. To transmit a selection command, a signal generated by pressing a key is fed to encoder logic 720. Encoder logic 720, in turn, sends a signal to controller 730 identifying the “pressed” key. A command is then generated including digital information for selecting a particular format.

Preferably, the command is transmitted via an appropriate wireless protocol supported by driver 740 and transducer 640. In one application, a protocol using in addition to the data bits, a START, STOP and PARITY bits similar to common computer data transfers, are transmitted to the hearing aid 600 for selecting a particular acoustical format. However, any standard protocol for encoding and transmitting data over a wireless link can be used to support data transfers.

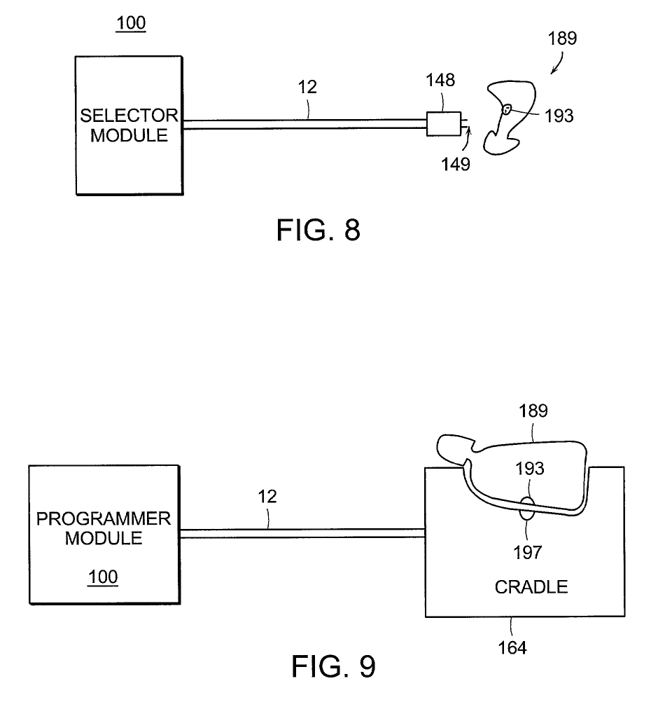

FIG. 8 is a block diagram of a programmer module for programming a hearing aid according to certain principles of the present invention.

Programmer module 100 includes cable 12 for transmitting information such as commands to hearing aid device 189. A connector assembly 148 includes terminals 149 such as pogo pins for making connection with contacts 193 coupled to circuit 325. To program a hearing aid device, a patient engages hearing aid 189 and connector assembly 148 so that terminals 148 touch contacts 193 and a key is press on programmer module 100.

In one application, contacts 193 of hearing aid device 189 are disposed in a small cavity so that after programming, contacts 193 are generally protected from exposure to human skin when hearing aid 189 is placed in an ear canal. As previously discussed, a command typically includes digital information that is stored in hearing aid device 189 for selecting an acoustical format.

In a preferred application, hearing aid device 189 is blank so that a patient can program an appropriate acoustical format. A programmed acoustical format can define an acoustical response of hearing aid device 189 for an entire detectible range of inputs. Thus, programming hearing aid device 189 is a simple process.

In a specific application, hearing aid 189 is disposable device that can be programmed only once. That is, a programmed format is optionally permanent so that the device cannot be re-programmed.

Programmer module 100 optionally includes a single keypad for programming an acoustical format of a hearing aid device 189. Thus, a patient can visit an audiologist's office to determine which of multiple selectable acoustical formats is proper for the patient and thereafter program the correct acoustical format using a programmer module 100 that is set to program the appropriate acoustical format when a key is pressed. Consequently, an un-programmed hearing aid device 189 can be mailed to a user and a hearing aid 189 can be programmed at a patient's home rather than having to an audiologist's office.

Consider a production aspect of providing a blank hearing aid device 189 for programming by a patient. Since the shape of an ear canal varies, a size of tip of hearing aid 189 typically is provided in one of three sizes. When an audiologist supports a line of hearing aid devices each of which is programmed to one of ten selectable fixed formats, there are potentially 30 different types of hearing aids devices that must be stocked. According to one aspect of the present invention, only three types of hearing aids 189 having a different tip need be stocked, each of which can be programmed to a selected format via programmer module 100.

FIG. 9 is a block diagram illustrating a cradle for programming a hearing aid device.

As shown, cradle 164 is coupled to programmer module 100 via cable 12 as previously discussed. Cradle 164 includes terminals that are coupled to contacts 193 of hearing aid test unit 189 for programming. Preferably, cradle 164 is contoured to match a contour of hearing aid device 189 so that terminals 197 and contacts 193 touch when a user places hearing aid device 189 in the cradle. Thus, it is a simpler process to align the hearing aid device 189 for programming.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for selecting an acoustical response of a hearing aid, the method comprising the steps of:
selecting one of multiple acoustical formats of the hearing aid by transmitting a command;
receiving the command at the hearing aid to determine which of the multiple acoustical formats is selected by a user; and
compensating for a variation in a component of the hearing aid device based on a compensation factor that is previously programmed in the hearing aid, the compensation factor being used to adjust the acoustical response of the hearing aid so that a selected acoustical format of the hearing aid conforms to a standard.

2. A method as in claim 1, wherein the command includes digital data that is stored in a memory device of the hearing aid to select an acoustical format.

3. A method as in claim 1, wherein the received command includes digital data that is latched to drive at least one input to a digital filter that defines the acoustical response of the hearing aid.

4. A method as in claim 1, wherein the user presses a keypad of a wireless transmitter module to select the acoustical format and a corresponding command is transmitted via a wireless signal to the hearing aid device to program the acoustical format.

5. A method as in claim 1, wherein the hearing aid is disposable.

6. A method as in claim 1, wherein a selection of a format by a user is permanent so that the hearing aid cannot be reprogrammed.

7. A method as in claim 1, wherein an acoustical format is selected by holding the hearing aid device to a phone receiver and pressing at least one keypad.

8. A method as in claim 1, wherein the command is transmitted via a wireless signal.

9. A method as in claim 2, wherein the digital data for selecting an acoustical format is stored in a volatile memory device.

10. A method as in claim 9, wherein the volatile memory device is RAM (Random Access Memory).

11. A method as in claim 1, wherein a selection of a format by a user is temporary so that the hearing aid can be subsequently reprogrammed with a different acoustical format.

12. A method as in claim 1 further comprising the steps of:
filtering an acoustical input of the hearing aid to detect an audible programming command; and
programming the hearing aid according to the audible programming command.

13. A method as in claim 12, wherein the audible programming command is generated via DTMF (Dual Tone Multiple Frequency) signals.

14. A method as in claim 1 further comprising the step of:
amplifying an acoustical input of the hearing aid based upon a selected acoustical format.

15. A method as in claim 14 further comprising the step of:
storing a compensation factor in memory of the hearing aid corresponding to characteristics of a tested component disposed in the hearing aid; and
modifying an acoustical response of the hearing aid based upon the compensation factor.

16. A method for modifying an acoustical response of a hearing aid, the method comprising the steps of:
testing a component to be used in the hearing aid by measuring a characteristic of the component;
identifying an appropriate compensation factor to correct for a variation in the component; and
storing the compensation factor in a memory device to compensate for the component disposed in the hearing aid.

17. A method as in claim 16 further comprising the step of:
compensating for the variation in the component of the hearing aid device so that an overall acoustical response of the hearing aid conforms to a standard.

18. A method as in claim 16, wherein the component is a microphone used in the hearing aid.

19. A method as in claim 16, wherein the component is a speaker used in the hearing aid.

20. A method as in claim 16, wherein the component is an assembly including an electronic circuit.

21. A method as in claim 20, wherein the electronic circuit includes an amplifier.

22. A method as in claim 20, wherein the component is an assembly including a memory device in which a compensation factor is stored.

23. A method as in claim 22, wherein the compensation factor is stored in the memory device prior to assembly of the component in a hearing aid.

24. A method as in claim 16, wherein the memory device is EEPROM (Electrically Erasable Programmable Read Only Memory).

25. A method as in claim 16 further comprising the step of:
storing encoded data in the memory device for selecting one of multiple programmable acoustical responses of the hearing aid.

26. A method as in claim 16 further comprising the step of:
latching a digitally encoded compensation factor into a register device that drives circuitry disposed between a microphone and speaker of the hearing aid to compensate for the variation in the component.

27. A method as in claim 16 further comprising the step of:
testing multiple components of a similar type and grouping the components based on a corresponding deviation from a standard.

28. A method as in claim 27 further comprising the steps of:
assigning a compensation factor to a group of tested components having similar characteristics; and
programming the hearing aid that includes a component selected from a particular group with a corresponding assigned compensation factor.

29. A method as in claim 16, wherein the compensation factor is used to adjust a gain of the hearing aid device.

30. A method as in claim 16, wherein the compensation factor is used to adjust an offset of the hearing aid device.

31. A method as in claim 20, wherein the characteristic response is an acoustical response.

32. A method for selecting an acoustical response of a hearing aid, the method comprising the steps of:
selecting one of multiple acoustical formats of the hearing aid by transmitting a command;
receiving the command at the hearing aid to determine which of the multiple acoustical formats is selected by a user; and
providing a patient with a programmer module that is temporarily coupled to the hearing aid for programming an acoustical format.

33. A method as in claim 32, wherein the command includes digital data that is stored in a memory device of the hearing aid to select an acoustical format.

34. A method as in claim 32, wherein the received command includes digital data that is latched to drive at least one input to a digital filter that defines the acoustical response of the hearing aid.

35. A method as in claim 32, wherein the user presses a keypad of the programmer module to select the acoustical format and a corresponding command is transmitted via a signal to the hearing aid device to program the acoustical format.

36. A method as in claim 32, wherein the hearing aid is disposable.

37. A method as in claim 32, wherein a selection of a format by a user is permanent so that the hearing aid cannot be reprogrammed.

38. A method as in claim 32 further comprising the step of:
amplifying an acoustical input of the hearing aid based upon a programmed acoustical format.

39. A method as in claim 32 further comprising the step of:
storing a compensation factor in memory of the hearing aid corresponding to characteristics of a tested component disposed in the hearing aid; and
modifying an acoustical response of the hearing aid based upon the compensation factor.
